(19) United States
(12) Patent Application Publication
(10) Pub. No.: US 2012/0107515 A1
(43) Pub. Date: May 3, 2012

(54) Method for applying polymeric coatings with trigger/pump sprayer applicator

(76) Inventor: Matthew L. Johnston, Toms River, NJ (US)

(21) Appl. No.: 13/065,179

(22) Filed: Mar. 16, 2011

Related U.S. Application Data
(60) Provisional application No. 61/456,100, filed on Nov. 1, 2010.

(51) Int. Cl. B05D 1/02

(52) U.S. Cl. 427/427.4

(57) ABSTRACT

Polymeric coatings are applied to a surface using a trigger or a pump type spray head attached to a suitable container for said coatings. The sprayer may be pre-primed with a solvent to aid in initial sprayability of the coating.

### CROSS-REFERENCE TO RELATED APPLICATIONS

Applicant claims priority of U.S. Provisional Patent Application 61/456/100, filed Nov. 1, 2010.

### SUMMARY OF THE INVENTION AND DESCRIPTION OF RELATED ART

The invention has specific utility in the military application of CARC, (chemical agent resistant coating). It is applied to military vehicles to provide resistance to chemical and biologic agents. The CARC coating permits vehicles and equipment to be more easily decontaminated in the event of exposure to chemical and biological agents.

In addition, CARC provides both visual camouflage and IR signature management. It is the IR signature management that is critical to maintain true camouflage. For example, by mimicking the IR signature of a heavily wooded environment, a vehicle having a woodland camo CARC finish is more difficult to identify because its IR signature appears to be the same as its surrounding environment.

As many passive missile guidance systems use IR signatures as a primary means of tracking targets, effective application of CARC coating enhances survivability. As will now be apparent, it is important to be able to “touch up” the CARC coating with touch up paint that possesses these same qualities.

The present invention provides a trigger or a vertical pump type sprayer applicator to allow the CARC material to be applied in this convenient manor.

One prior art device for applying a touch up CARC coating is shown and described in U.S. Pat. No. 7,338, 27, issued Mar. 4, 2008, commonly assigned. That applicator uses a two component CARC coating requiring mixing before application. The prior use of two component CARC has thus limited the effectiveness and ease of use of aerosol spray applicators for CARC.

Another device is sold under the trademark PREVAL. While aerosol cans of coatings are commonplace, it has been difficult to put single component moisture cure CARC coating into a traditional aerosol container. The coating cures by reaction with moisture and it has proven difficult to exclude moisture during the filling of aerosol cans. It is however possible to use a can of aerosol propellant of the type sold under the trademark PREVAL to make a type of aerosol paint. The PREVAL sprayer unit includes a pressurized container with a plastic tube to take up the paint. The unit also has threads so that a plastic bottle containing a small quantity of paint may be attached to the PREVAL unit and sprayed by aerosol. The unit will not operate when held at an angle greater than 45° and clogs easily.

The applicators of the present invention may also be used to apply all types of polymeric coatings in other military applications as well as for commercial and industrial uses. These applicators work well with polymeric coatings such as urethane, epoxy, latex, acrylic, etc., regardless of water or solvent dispersions and regardless of single or dual component formats. The applicator is characterized by its atomization of polymeric coatings by means of an airless/non-propellant transference of the liquid coating from a reservoir, thus channeled through a restricted orifice nozzle by manual contraction/squeezing of a lever or pump actuated pumping assembly.

### DETAILED DESCRIPTION OF THE INVENTION

I have found that certain trigger and pump sprayers can be used to apply the polymeric coatings described above. The products described below have been tested with: CARC Single-Component polyurethane; CARC Two-Component polyurethane; waterborne epoxy primer; and solvent borne epoxy primer.

I have further found that pre-priming the said pump spray assembly with a solvent or other chemically nonfunctional liquid, which is compatible with the liquid coating itself, aids in initial sprayability of the liquid polymeric coating. The act of pre-priming the said pump assembly additionally serves to evacuate air and other contaminants from the fluid channels thus ensuring the chemical integrity and purity of the polymeric coating being applied.

These sprayers are:
1. Trigger action with pump offset at 45-degrees, Item HT-22210, available from McKernan Packaging Clearinghouse, PO Box 7281, Reno, Nev. 89510;
2. Trigger action with pump offset at 90-degrees; Item 0240004, available from Parish Maintenance Supply Corp., PO Box 185, 114 Palmeter St., Syracuse, N.Y. 13206;
3. Trigger action with inline pump at 180-degrees, Item HT-18610, available from McKernan Packaging Clearinghouse.
4. Push button action with inline pump at 180-degrees, Item HF-22771, available from McKernan Packaging Clearinghouse.

The above sprayers may be attached to the container distributed by CCL Container; 1 Llodio Drive; Hermitage, Pa. 16148. This is a seamless, drawn aluminum container which is epoxy-phenolic lined and thread impressed/stamped within the aluminum neck.

Further modifications to the methods and apparatus of the invention may be made without departing from the spirit and scope of the invention.

I claim:

1. The method of applying a polymeric coating to a surface comprising the steps of: filing a container with a polymeric coating, affixing a trigger or pump sprayer to said container and applying said polymeric coating to a surface by manipulating said sprayer.

2. The method of claim 1 wherein said polymeric coating is chemical agent resistant coating.

3. The method of applying chemical agent resistant coating to a surface comprising the steps of filing a container having a trigger or pump sprayer attached thereto with chemical agent resistant coating, and spraying said chemical agent resistant coating onto a surface.

4. A method of painting comprising the steps of: connecting a trigger or pump type sprayer to a container and spraying the contents of the container onto a surface.

5. The method of claim 1 further including the step of pre-priming said trigger or pump sprayer
